(19) United States
(12) Patent Application Publication
(10) Pub. No.: US 2026/0066842 A1
(43) Pub. Date: Mar. 5, 2026

(54) EXPANDABLE SOLAR PANEL ARRAY SYSTEM AND KITS FOR SAME

(71) Applicant: David A. Deeks, Sidney (CA)

(72) Inventor: David A. Deeks, Sidney (CA)

(21) Appl. No.: 19/106,125

(22) PCT Filed: Aug. 27, 2023
(86) PCT No.: PCT/CA2023/051132

§ 371 Date: Feb. 24, 2025

Related U.S. Application Data
(60) Provisional application No. 63/401,612, filed on Aug. 27, 2022.

(51) Int. Cl. H02S 30/20; H02S 10/20; H02S 10/40; H02S 20/30; H02S 30/10

(52) U.S. Cl. CPC H02S 30/20; H02S 10/20; H02S 10/40; H02S 20/30; H02S 30/10

(57) ABSTRACT

Described are various embodiments of an expandable solar panel array and a solar panel installation kit for installing at least two solar panels on a vehicle, such array and/or kit having a generally nested configuration of solar panels or structures. Some embodiments include a wire guide assembly which is configured to route electrical wiring from an upper solar panel or structure to at least partially beneath a lower solar panel or structure, so as to at least partially retain the electrical wiring during translation of the upper solar panel or structure relative to the lower solar panel or structure, thereby to avoid wiring entanglement and/or damage to the lower solar panel or structure in use.

### RELATED APPLICATION

The instant application claims the benefit of priority to U.S. Provisional Patent Application Ser. No. 63/401,612, entitled “EXPANDABLE SOLAR PANEL ARRAY SYSTEM” and filed Aug. 27, 2022, the contents of which are fully incorporated herein by reference.

### FIELD OF THE DISCLOSURE

The present disclosure relates to solar panels, and in particular, to an expandable solar panel array system and a solar panel installation kit for installing at least two solar panels on a vehicle.

### BACKGROUND

Certain applications, such as recreational vehicles (RV's) or boats, require electrical power to power systems and equipment. These systems may require electrical power to be directly supplied or the electrical power to supplied to an electrical storage device, such as a battery.

A hard-line power supply from a power grid coupled to, for example, and an RV or a boat (i.e., shore power), is not always available, and therefore solar panel systems have been developed to supply electrical power, generally to keep a battery supplied. However, currently available solar panel systems for certain applications are not always capable of supplying the often-required power demand due to the amount of solar panel surface area exposed to the sun. Furthermore, in some applications, such as RV's, boats or other transportation-based devices, there is limited surface on the vehicle to mount the required number of solar panels to meet the power demands. Also, due to vehicles moving from one location to another, having a large number of solar panels laid out to generate the required amount of electrical power may not be practical for transport or movement of the vehicle. Indeed, although some solar panel arrangements rely on extendable solar panel arrangements to meet power demands, these arrangements typically require complex assembly and are therefore time-consuming to assemble and/or disassemble. In an attempt to address these needs, various foldable or expandable configurations have been developed, as discussed below; however, commercial embodiments remain lacking on several fronts.

U.S. Pat. No. 3,698,958 issued Oct. 17, 1972 to Williamson et al., and entitled “SOLAR PANEL” discloses a foldable solar panel assembly comprised of a number of generally planar and rectangular solar panels hinged edge-to-edge. The solar panels are joined by means of adhesive tape or other suitable means, to provide a solar panel assembly characterized by a large effective area with minimum stowage volume.

U.S. Pat. No. 6,091,016 issued Jul. 18, 2000 to G. Kester, and entitled “SOLAR PANEL ASSEMBLY” discloses a number of rectangular solar panels being interconnected by mutually parallel hinges. The panels are folded in a zigzag manner into a package when not in use, and are unfolded and situated alongside one another in one plane when in use.

U.S. Pat. No. 6,284,967 issued Sep. 4, 2001 to Hakan et al., and entitled “SOLAR GENERATOR WITH FOLDABLE PANELS ESPECIALLY FOR A SPACECRAFT” discloses a solar generator. The solar generator has a plurality of first collector panels hinged to each other in a column extending in a first direction when unfolded, and a plurality of second panels coupled to the first panels so that the second panels are unfolded in a second direction only after the first panels are unfolded. The second panels are coupled to the first panels by journal struts or hinges.

U.S. Pat. No. 8,109,472 issued Feb. 7, 2012 to Keller et al., and entitled “COLLAPSIBLE STRUCTURES WITH ADJUSTABLE FORMS” discloses deployable structures which can be used for solar arrays. The deployable structures may have expandable longerons which are adjustably coupled with supporting structures, such that an angle between the supporting structures is adjustable. In one embodiment, the solar array has a central solar panel and two wing solar panels which deploy at an angle not coplanar with the central solar panel.

U.S. Pat. No. 10,773,833 issued Sep. 15, 2020 to Harvey et al., and entitled “PANEL FOR USE IN A DEPLOYABLE AND CANTILEVERED SOLAR ARRAY STRUCTURE” discloses a deployable solar array structure. The panel structure comprises first and second planar panel sections with an intermediate panel section therebetween. The two planar panel sections are orientated in a V-tent-like shape when in use and are coplanar when not in use.

United States Patent Application Publication No. 2008/0223431 A1 published Sep. 18, 2008 to R. Chu and entitled “FOLDABLE SOLAR PANEL”, discloses a foldable solar panel which comprises multiple rigid cell assemblies, multiple folding cell assemblies and multiple primary flexible seams. Each folding cell assembly comprises two symmetric halves and a flexible secondary seam which connects the halves, allowing the halves to fold inwards onto each other. Various seams allow folding of the panel into a smaller volume for transportation or storage.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for an expandable solar panel array system and related kit that overcome some of the drawbacks of known designs, or at least, provides a useful alternative thereto. Some aspects of this disclosure provide examples of such an expandable solar panel array system and related kit.

In accordance with one aspect, there is provided an expandable solar panel array system, comprising at least one static solar panel located beneath at least one movable solar panel, the at least one movable solar panel being slidably translatable along a travel path with respect to the at least one static solar panel, a first frame member and a second frame member, each having a lower frame portion and an upper frame portion, the lower frame portion of the first frame member and the lower frame portion of the second frame member being coupled together along opposing sides of the at least one static solar panel, the upper frame portion of the first frame member and the upper frame portion of the second frame member each having a sliding mechanism associated therewith and intervening to opposing sides of the at least one movable solar panel, the sliding mechanism is configured to slidably translate the at least one movable solar panel along the travel path with respect to the at least one static solar panel, and a wire guide assembly configured to at least partially receive therein electrical wiring for the at least one movable solar panel and to route same at least partially beneath the at least one static solar panel such that the electrical wiring is at least partially retained within the wire guide assembly during translation of the at least one movable solar panel.

In one embodiment, the sliding mechanism is configured such that the at least one movable solar panel is slidably translatable between a retracted configuration, wherein the at least one static solar panel is at least partially covered, and an extended configuration, wherein the at least one static solar panel is at least partially exposed. In one embodiment, when in the extended configuration, the at least one movable solar panel is orientated at a plane above or in line with the at least one static solar panel.

In one embodiment, the wire guide assembly is removably coupled to one end of the at least one movable solar panel and is configured to extend at least partially beneath the at least one static solar panel. In one embodiment, the wire guide assembly comprises a conduit for guiding the electrical wiring for the at least one movable solar panel at least partially beneath the at least one static solar panel. In one embodiment, the conduit comprises a substantially 90-degree bend. In one embodiment, the wire guide assembly further comprises a resiliently expandable conduit coupled to a free end of the conduit, the resiliently expandable conduit extending the wire guide assembly to a wiring harness located beneath the at least one static solar panel.

In one embodiment, each sliding mechanism comprises complementary sliding faces located on the upper frame portions of the first and second frame members, and on opposing sides of the at least one movable solar panel. In one embodiment, each sliding mechanism comprises a drawer slide.

In one embodiment, the expandable solar panel array system further comprises an actuator mechanism for translating the at least one moveable solar panel along the travel path. In one embodiment, the actuator mechanism comprises a linear actuator mounted to a bottom side of the at least one static solar panel, and an actuator arm having a first end and a second end, the first end coupled to the linear actuator and the second end coupled to the at least one movable solar panel, the actuator arm being extendable along the travel path beneath the at least one movable solar panel. In one embodiment, the actuator arm is located at a mid-point of the at least one movable solar panel. In one embodiment, the second end of the actuator arm is releasably coupled to one edge of the at least one movable solar panel by a locking pin.

In one embodiment, any one or both of the first frame member and the second frame member have an attachment point for removably coupling the expandable solar panel array system to a surface. In one embodiment, the surface comprises a portion of a mounting bracket which is couplable to a vehicle surface.

In one embodiment, the attachment point is configured to provide radial articulation of the expandable solar panel array system relative to the surface. In one embodiment, expandable solar panel array system further comprises a tilt actuator located between an edge of the at least one movable solar panel and framing around the at least one static solar panel for tilting the edge of the at least one movable solar panel upwards relative to the at least one static solar panel.

In one embodiment, the travel path has a predetermined length.

In one embodiment, the lower frame portion and the upper frame portion are connected via a horizontal frame portion such that the upper frame portion is spaced from the lower frame portion to accommodate the sliding mechanism.

In one embodiment, the expandable solar panel array system further comprises an electronic control box configured to control the actuator mechanism for movement of the at least one moveable solar panel along the travel path relative to the at least one static solar panel. In one embodiment, the electronic control box is further configured to receive control input from a switching unit. In one embodiment, the switching unit comprises a handheld remote control device.

In one embodiment, the at least one static solar panel and the at least one movable solar panel are electrically wired to transmit electrical energy generated in use to any one of an electrically operated device and an electrical storage unit.

In one embodiment, the expandable solar panel array system further comprises a wireless short-range communications module which is configured to wirelessly communicate predefined electrical parameters of the expandable solar panel array system to a remote transceiver.

In one embodiment, the at least one static solar panel comprises first and second static solar panels arranged within said first frame member and said second frame member to abut one another in a first plane. In one embodiment, the first frame member and the second frame member together form a rigid outer frame which is mountable to a vehicle surface. In one embodiment, the at least one movable solar panel comprises first and second movable solar panels arranged within independent housings each suspended above the first and second static solar panels by means of the sliding mechanism. In one embodiment, the first and second movable solar panels are slidable in opposed directions to respective extended configurations to at least partially expose the first and second static solar panels beneath them. In one embodiment, the wiring guide assembly comprises first and second wiring guide assemblies, each routing electrical wiring from each of the first and second movable solar panels at least partially underneath the first and second static solar panels, respectively.

In accordance with one aspect, there is provided a solar panel installation kit for installing at least two solar panels on a vehicle. The solar panel installation kit comprises a rigid frame comprising at least two solar panel mounting structures arranged in a stacked configuration, the at least two solar panel mounting structures comprising an upper solar panel mounting structure slidably engaged with a lower solar panel mounting structure via a sliding mechanism such that the upper solar panel mounting structure is slidably translatable with respect to the lower solar panel mounting structure along a travel path from a retracted configuration to an extended configuration, at least two solar panels shaped and dimensioned to mount to the at least two solar panel mounting structures, and at least one wiring guide assembly couplable to the upper solar panel mounting structure for at least partially receiving therein electrical wiring from an upper solar panel and routing the electrical wiring at least partially beneath the lower solar panel mounting structure, such that the electrical wiring is at least partially retained within the at least one wire guide assembly during translation of the upper solar panel mounting structure.

In one embodiment, the lower solar panel mounting structure comprises a first frame member and a second frame member on opposing sides of the lower solar panel mounting structure, each having a lower frame portion used to couple a lower solar panel to the lower solar panel mounting structure.

In one embodiment, the first frame member and the second frame member each comprise an upper frame portion on which at least a portion of the sliding mechanism is located.

In one embodiment, the upper solar panel mounting structure at least partially covers the lower solar panel mounting structure in the retracted configuration and the upper solar panel mounting structure at least partially exposes the lower solar panel mounting structure in the extended configuration.

In one embodiment, the upper solar panel mounting structure is orientated at a plane above or in line with the lower solar panel mounting structure when in the extended configuration.

In one embodiment, the wire guide assembly comprises a conduit having a substantially 90-degree bend. In one embodiment, the wire guide assembly further comprises a resiliently expandable conduit couplable to a free end of the conduit, the resiliently expandable conduit in use extending the wire guide assembly to a wiring harness located beneath the lower solar panel mounting structure.

In one embodiment, the sliding mechanism comprises complementary sliding faces located on the upper frame portion of the first frame member and the second frame member, and on opposing sides of the upper solar panel mounting structure. In one embodiment, the sliding mechanism comprises a drawer slide.

In one embodiment, the solar panel installation kit further comprises an actuator mechanism for translating the upper solar panel mounting structure along the travel path, the actuator mechanism comprising a linear actuator mountable to a bottom side of the lower solar panel mounting structure, and an actuator arm having a first end and a second end, the first end couplable to the linear actuator and the second end couplable to the upper solar panel mounting structure, the actuator arm being extendable along the travel path beneath the lower solar panel mounting structure.

In one embodiment, the solar panel installation kit further comprises a mounting bracket for removably coupling the lower solar panel mounting structure to a vehicle surface.

In one embodiment, the solar panel installation kit further comprises a tilt actuator to be positioned between an edge of the upper solar panel mounting structure and the lower solar panel mounting structure for tilting the edge of the upper solar panel mounting structure upwards relative to the lower solar panel mounting structure.

In one embodiment, the solar panel installation kit further comprises an electronic control box configured to control the actuator mechanism. In one embodiment, the solar panel installation kit further comprises a handheld remote control device which in use communicates control input to the electronic control box.

In one embodiment, the solar panel installation kit further comprises an electrical storage unit for storing electrical energy generated by the at least two solar panels.

In one embodiment, the solar panel installation kit further comprises a wireless short-range communications module which is configurable to wirelessly communicate predefined electrical parameters to a remote transceiver.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1A is a perspective view of an embodiment an expandable solar panel array of the instant disclosure in an expanded configuration;

FIG. 1B is a perspective view of the expandable solar panel array of FIG. 1A in a retracted configuration;

FIG. 2 is an end view of one side of an embodiment the expandable solar panel array showing end portions of respective static and moveable solar panels arranged and coupled to a frame;

FIG. 3 is a top plan view of an embodiment of the expandable solar panel array in an expanded configuration;

FIG. 4 is side view of an embodiment of the expandable solar panel array in an expanded configuration, with the frame removed;

FIG. 5 is a top plan view of an embodiment of the expandable solar panel array in a retracted configuration;

FIG. 6 is a side view of an embodiment of the frame of the expandable solar panel array;

FIG. 7 is a side view of an embodiment of the expandable solar panel array in a retracted configuration, showing the arrangement of the static and movable solar panels with the frame removed;

FIG. 8 is a side view of an embodiment of the expandable solar panel array in a retracted configuration showing the arrangement of the static and movable solar panels with the frame removed, illustrating one embodiment of respective wire guide assemblies and wires;

FIG. 9 is a side view of an embodiment of the expandable solar panel array in an expanded configuration showing the arrangement of the static and movable solar panels with the frame removed, illustrating one embodiment of respective wire guide assemblies and wires;

FIG. 10 is a partial end view of a static solar panel coupled to a lower frame portion, illustrating an upper frame portion and sliding mechanism in further detail, in accordance with one embodiment;

FIG. 11 is a bottom view of an embodiment of the expandable solar panel array in a retracted configuration, showing one embodiment of respective actuators and electronic control boxes as connected to the static solar panels;

FIG. 12A is a cut-away end view of the relationship of portions of the static and movable solar panels coupled by coupling means to an actuator arm, in accordance with one embodiment;

FIG. 12B is an end view of the relationship of portions of the static and movable solar panels coupled by coupling means to an actuator arm, in accordance with one embodiment;

FIG. 12C is a top view of a portion of a movable solar panel illustrating a coupling means used to couple an actuator arm thereto, in accordance with one embodiment;

FIG. 13 is a bottom plan view of the static solar panels of an embodiment of the expandable solar panel array in a retracted configuration showing respective actuators coupled to respective movable solar panels, in accordance with one embodiment;

FIG. 14A is a top perspective view of an embodiment a wire guide assembly forming part of the expandable solar panel array in one embodiment;

FIG. 14B is a side view of the wire guide assembly shown in FIG. 14A; and

FIG. 14C is a bottom perspective view of the wire guide assembly shown in FIGS. 14A and 14B.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system and kit disclosed herein. No implementation described below limits any claimed implementation and any claimed implementations may cover processes, apparatuses or kits that differ from those described below. The claimed implementations are not limited to apparatuses, processes or kits having all of the features of any one embodiment described below or to features common to multiple or all of the embodiments described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this disclosure belongs.

Throughout the specification and claims, the following terms take the meanings explicitly associated herein, unless the context clearly dictates otherwise. The phrase “in one embodiment” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. In addition, throughout the specification, the meaning of the singular forms “a,” “an,” and “the” include plural references unless the context clearly dictates otherwise. The meaning of “in” includes “in” and “on.” The term “comprising” as used herein will be understood to mean that the list following is non-exhaustive and may or may not include any other additional suitable items, for example one or more further feature(s), component(s) and/or element(s) as appropriate.

In this specification, the term “nestable” or derivations thereof may be used interchangeably with the term “stackable” or derivations thereof, and indeed may refer to a stacking of solar panels, with one or more solar panels arranged on one top of another, in a vertical orientation when in a retracted configuration. As such, “nestable” is generally not intended to refer specifically to one component being located inside another as such, or vice versa, although it may in some embodiments.

In this specification, unless the context indicates otherwise, the term “vehicle” is intended to be interpreted broadly, encompassing both motored and manual vehicles, which are capable of or used for the transportation of people or goods. To provide some non-limiting examples, “vehicle” may include any one of: a passenger vehicle, a bus, a truck, a motorcycle, a bicycle, a boat, a trailer, a service vehicle or the like. In some embodiments, as the context will indicate, “vehicle” comprises a recreational vehicle (RV) or van, although the disclosure is not intended to be limited thereto.

As noted above, several expandable solar panel systems are known in the art, for both commercial and domestic use cases. Notwithstanding these options, domestic uptake of solar panel systems, particularly for recreational vehicles, remains low. This can at least partly be attributed to the complexity of conventional solar panel installations, and/or the limited power supply generated by such systems, amongst other reasons.

To help meet power demands, it may be desirable to develop a solar panel system which is expandable to expose more solar panels, for example when a vehicle is stationary, yet retractable or collapsible to make the solar panel system more compact for travel. Having the ability to make a solar panel system more compact for travel may reduce wind resistance and allow the solar panel system to be practically mountable to a vehicle for transport. Once a vehicle has arrived at its destination, the solar panel system could be expanded or deployed to expose more solar panels, increasing the surface area of the solar panels exposed to the sun and in turn, generating more power which may help to meet required power demands compared to currently known systems. Certain conventional solar panel installations which are indeed expandable to this end, suffer the drawback of wiring entanglement or damage to solar panels, typically caused by the wires or componentry when the solar panels are moved or folded, for example.

In some embodiments, the instant disclosure provides a simple, readily installable expandable solar panel array. Indeed, in some embodiments, the disclosure provides a lightweight solar panel installation which is suited to recreational vehicle use, without adding unnecessary weight which affects fuel consumption over long journeys. This compact retracted configuration provides a low profile solar panel assembly which is aerodynamic during vehicle travel and therefore does not dramatically impact fuel consumption after installation on a vehicle. In some embodiments, the instant disclosure provides a solar panel arrangement which can be easily overridden and managed in the event of a mechanical, electrical or other failure, which can be desirous, for example, when the vehicle is expected to traverse rugged terrain.

In some embodiments, the instant disclosure specifically provides for an expandable solar panel array in which the potential entanglement of electrical wiring between a static solar panel and a movable solar panel is addressed or avoided. For example, some embodiments provide for systems in which wiring guide assemblies are effectively employed so as to avoid entanglement. In some embodiments, a unique wiring guide assembly for this purpose is provided. It is to be appreciated that such a wiring guide assembly may exhibit further beneficial advantages, including, for example, preventing electrical wiring from rubbing, scratching or otherwise damaging a static solar panel beneath a movable solar panel.

In accordance with one embodiment of the instant disclosure, there is provided an expandable solar panel design, or expandable solar panel array 10, which may be useful in applications where compact solar panel storage is desirable, for travel or the like, yet in use it is desirable to have more surface area of solar panels exposed to gather more solar energy. For example, such an application may be desired in RV and marine applications, without limitation.

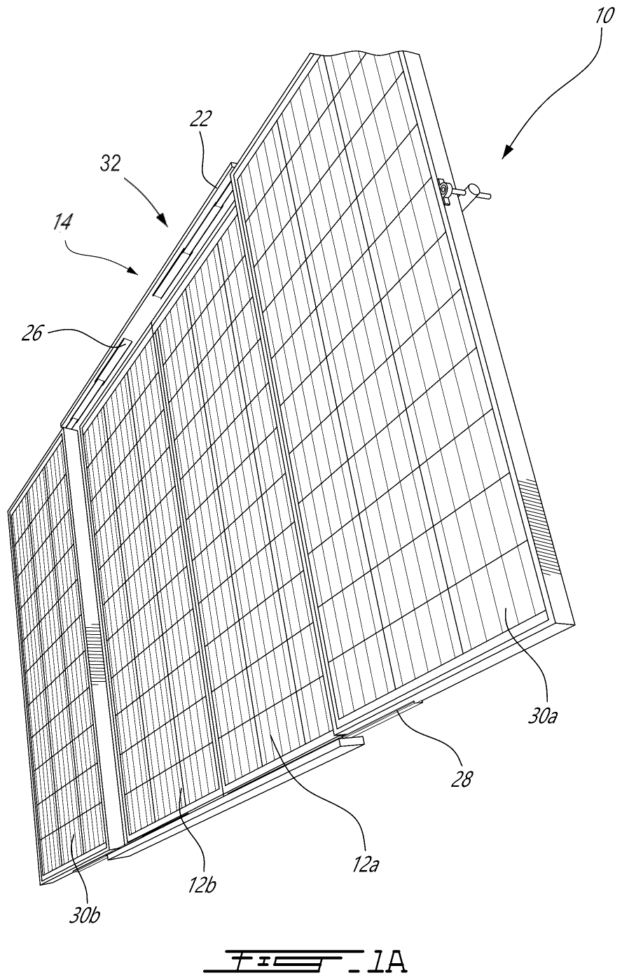

With reference to FIGS. 1A and 1, and in accordance with one exemplary embodiment, the expandable solar panel array 10 is shown in an expanded configuration and a retracted configuration, respectively. In general, the expandable solar panel array 10 is comprised of one or more static solar panels 12a and 12b (also referred to as “fixed lower panels” or variations thereof) mounted to a frame 14. In this embodiment, as shown, the one or more static solar panels 12a and 12b specifically comprise two static solar panels 12a and 12b which are located adjacent to one another in an abutting relationship. In general, the expandable solar panel array 10 is comprised of one or more movable solar panels 30a and 30b (also referred to as “slidable upper panels” or variations thereof) which are suspended above the static solar panels 12a and 12b and which are movable relative thereto. In this embodiment, as shown, the one or more movable solar panels 30a and 30b specifically comprise two movable solar panels 30a and 30b which are located adjacent to one another in an abutting relationship when in the retracted configuration (FIG. 1B) and are which are spaced apart from one another when in the expanded configuration (FIG. 1A), specifically on opposing sides of the two static solar panels 12a and 12b, in this embodiment. In this embodiment, the movement of the two movable solar panels 30a and 30b specifically comprises a sliding or translating movement, as will be discussed further below.

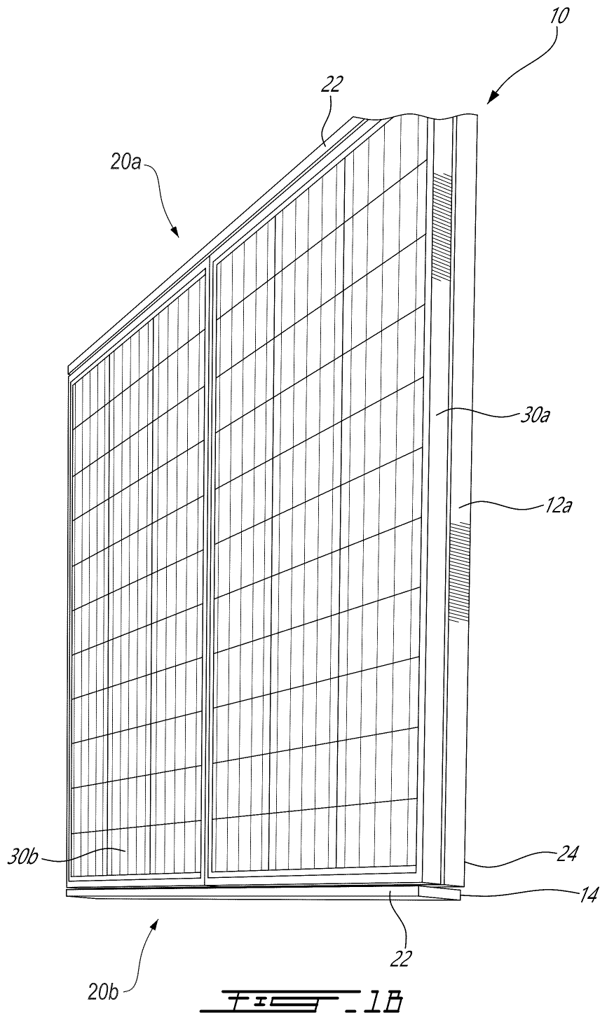

The frame 14 in this embodiment comprises at least a first side 20a and a second side 20b (FIG. 1), on opposed sides of the static solar panels 12a and 12b, although it is to be appreciated that variations of the frame 14 which secure or encase these static solar panels 12a and 12b would be workable in other embodiments. As shown in more detail in FIG. 2, the frame 14 has one or more attachment points 16 which may, in some embodiments, be coupled to a surface. In this embodiment, the one or more attachment points 16 specifically comprise four attachment points 16, two on either side of the frame 14, to ensure secure mounting to the surface. In this embodiment, the attachment points 16 are specifically couplable to an intervening bracket 18, as shown in FIG. 2, which in turn is mountable to a second surface (not shown), typically a vehicle surface such as a roof of an RV or trailer.

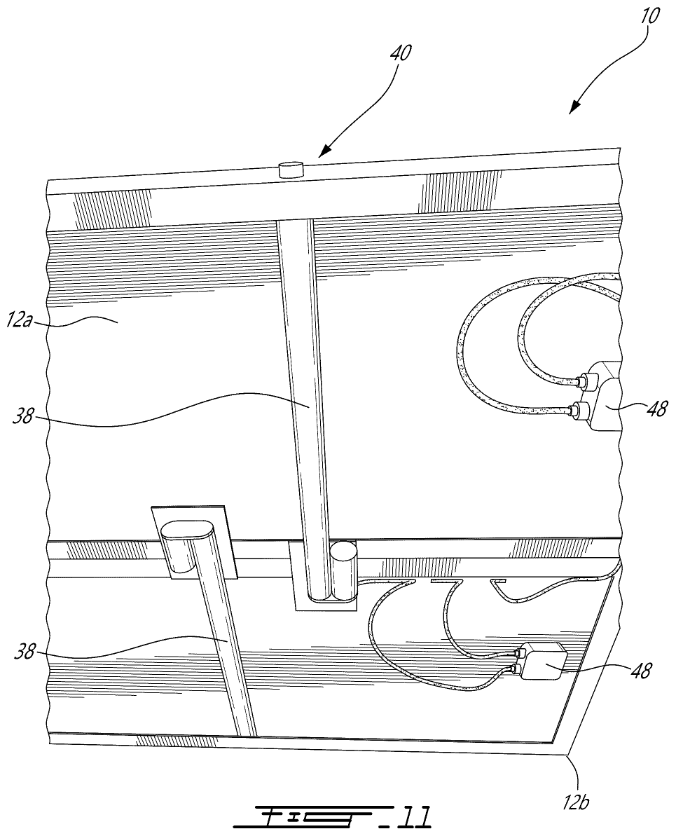

As shown in FIG. 2, each of the first side 20a and the second side 20b of the frame 14 have an upper frame portion 22 and a lower frame portion 24 in this embodiment. The upper frame portion 22 and the lower frame portion 24 are separated by a substantially horizontal frame portion 25, in this embodiment, which at least is configured to create space for receiving a frame slide mechanism 26. The upper frame portion 22 is specifically configured to have coupled thereto the frame slide mechanism 26 (further detail shown in FIG. 10). In use, the frame slide mechanism 26 engages and is slidable complementary to a solar panel slide mechanism 28 which is coupled to the two movable solar panels 30a and 30b. As such, the solar panel slide mechanism 28 is configured to slide relative to the frame slide mechanism 26 in a nestable arrangement similar to a drawer slide (or drawer runner), in this embodiment. The frame slide mechanism 26 and the solar panel slide mechanism 28, together, form a sliding mechanism 32, along which the movable solar panels 30a and 30b can be reversibly outwardly moved along a linear axis travel path to expose the static solar panels 12a and 12b and inwardly moved along the linear axis travel path to cover or conceal the static solar panels 12a and 12b. In some embodiments, the sliding mechanism 32 comprises complementary surfaces of the upper frame portion 22 and a side surface of each movable solar panel 30a and 30b. It is to be appreciated that other types of sliding mechanisms may be employed in other embodiments, without limitation.

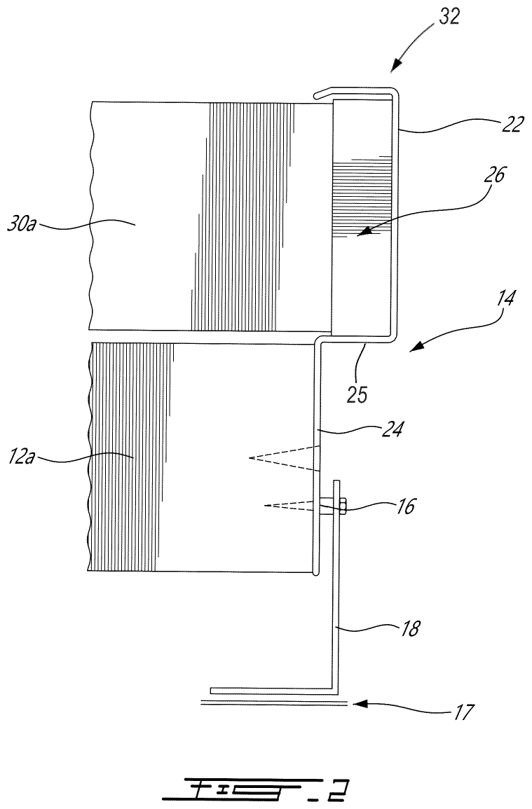

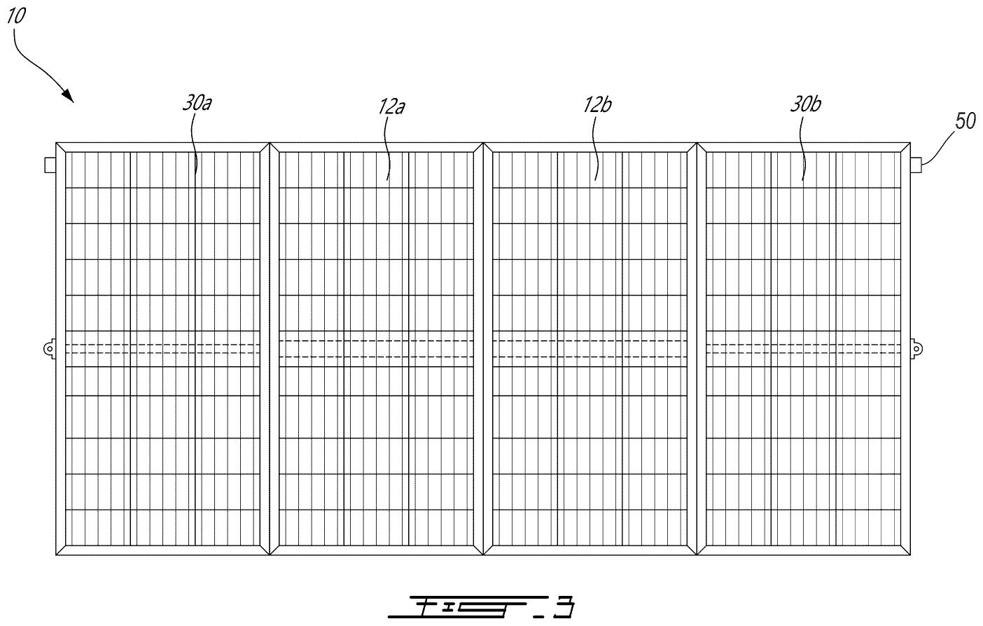

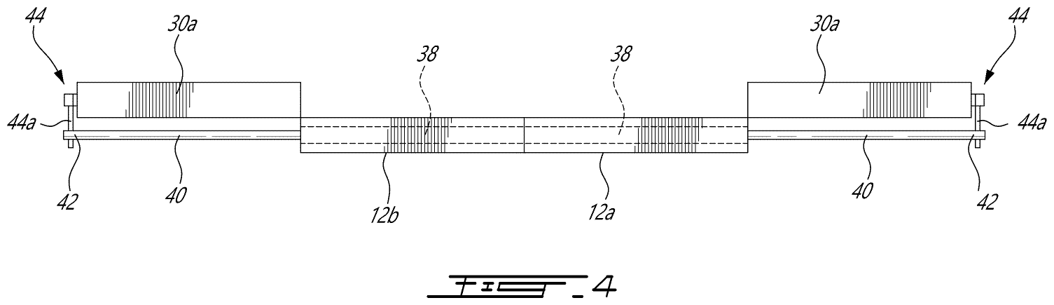

As noted, FIG. 1A shows the expandable solar panel array 10 in the expanded configuration, wherein the movable solar panels 30a and 30b have been slid or extended outwards along the linear travel path utilizing the sliding mechanism 32 to expose the static solar panels 12a and 12b beneath them. It is to be appreciated that, in various embodiments, the movable solar panels 30a and 30b may be slidable or extendable to predefined discrete extended configurations (for example, exposing half of the static solar panels 12a and 12b, or all of the static solar panels 12a and 12b), or otherwise may be slidable or extendable continuously along the length of the travel path such that a user can select the amount of the static solar panels 12a and 12b exposed and/or the overall width of the expandable solar panel array 10 in its extended configuration. As noted, FIG. 1B shows the exemplary embodiment of FIG. 1A wherein the movable solar panels 30a and 30b have been slid, or retracted inwardly, utilizing the sliding mechanism 32 to cover the one or more static solar panels 12a and 12b. Typically, the movable solar panels 30a and 30b would be fully retracted until abutting one another for the purposes of travel or storage. However, retraction of the movable solar panels 30a and 30b may also be employed by a user to select the amount of the static solar panels 12a and 12b exposed and/or the overall width of the expandable solar panel array 10 in its extended configuration. FIG. 3 shows a top plan view of the expandable solar panel array 10 in the fully expanded configuration and, similarly, FIG. 4 shows a side view of the expandable solar panel array 10 in the fully expanded configuration, with the frame 14 removed.

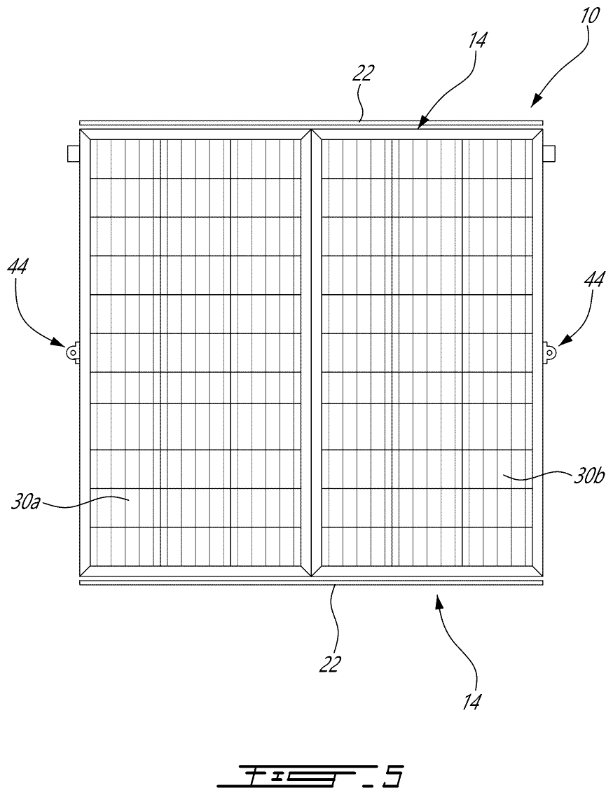

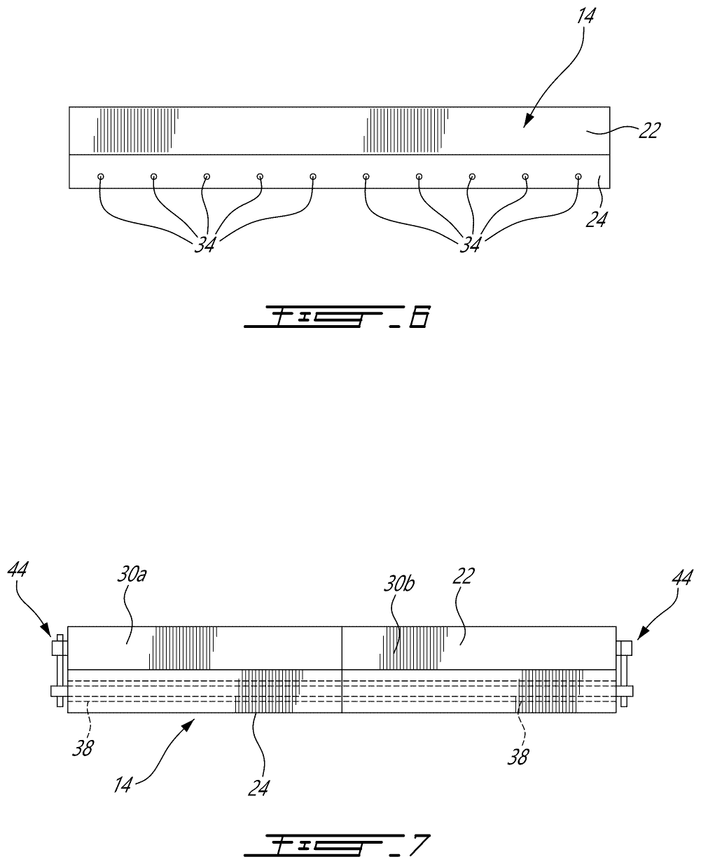

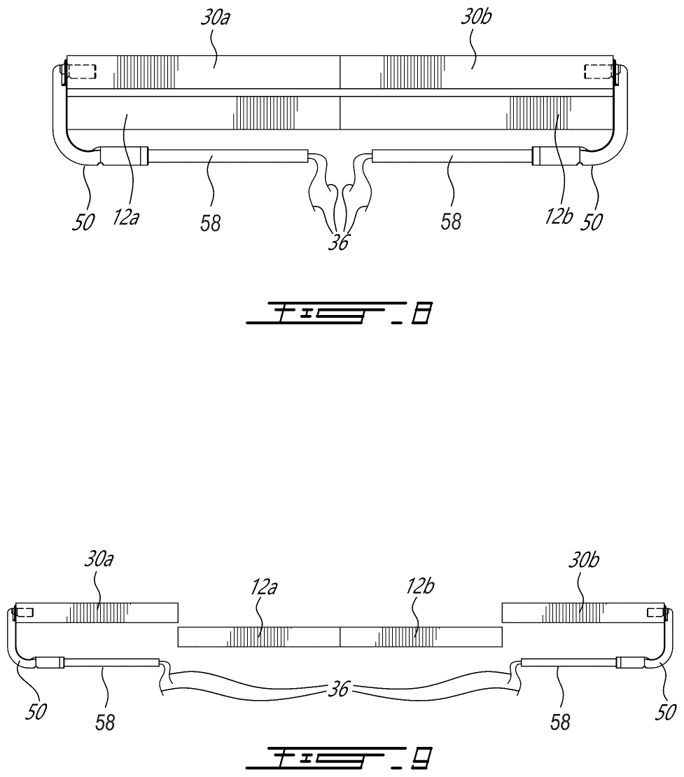

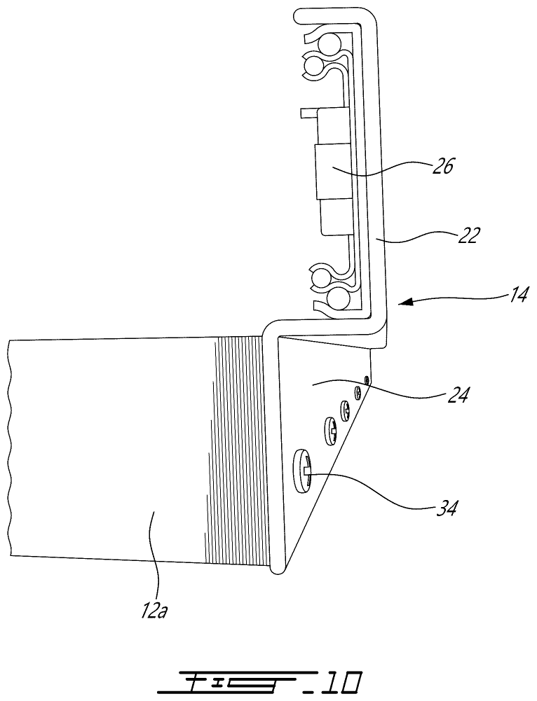

In this embodiment, the static solar panels 12a and 12b (or “lower panels”) are fastened together along their length with stainless steel self-tapping screws 34 (FIGS. 6 and 10) to the lower frame portion 24 of the frame 14. In some embodiments, a watertight seal (for example, Sikaflex®) is applied between the static solar panels 12a and 12b to at least partially halt water penetration which could affect the one or more linear actuators (described in more detail below), electrical wiring 36 (FIGS. 8 and 9) and/or other componentry under the fixed static solar panels 12a and 12b, for example. Notwithstanding same, some embodiments of the system 10 may be specifically configured such that each component is water resistant or waterproof and is capable of withstanding expected humidity or exposure. For example, the linear actuators may be encased in suitable water resistant or waterproof housings or the like.

The solar panels 12a, 12b, 30a and 30b and/or associated frame 14 or componentry employed in various embodiments will be selected for a given application, particularly taking into account sizes compatible for a particular installation and/or energy requirements. For instance, RV's have different arrays of roof vents, air conditioners, antennas, plumbing stacks and/or the like, varying between RV models and/or from manufacturer to manufacturer. Solar panels are manufactured in numerous lengths and widths and could be sized and planned in various configurations depending on the installation as well as of an output capacity as may be required and/or desired. Accordingly, the size and characteristics of the various components may be selected for a particular application, and thus vary amongst different embodiments.

In FIG. 3, there is shown a plan view of the expandable solar panel array 10 with the movable solar panels 30a and 30b in the expanded configuration, as in FIG. 1A, exposing the static solar panels 12a and 12b. FIG. 4 similarly shows the expandable solar panel array 10 in the expanded confirmation, however for simplicity, the upper frame portion 22 and the sliding mechanism 32 have been removed to show the linear actuators 38 and corresponding actuator arms 40, which form part of the expandable solar panel array 10 and which in use, function to slide the moveable solar panels 30a and 30b nestably inwardly and outwardly, as needed or on demand. As shown, the linear actuators 38 in this embodiment are located beneath the static solar panels 12a and 12b, specifically connected to an undersurface thereof, and the actuator arms 40 which extend from the linear actuators 38 engage the movable solar panels 30a and 30b on one end 42. In some embodiments, the linear actuators 38 are activated and/or deactivated by a fixed three pole double throw switch located at a convenient location. In other embodiments, the linear actuators 38 are activated and/or deactivated by another activation mechanism, which may include a handheld remote control device, such as a remote wireless key fob or other remote device operating with a wireless connection, such as by Bluetooth®, Wireless Fidelity (Wi-Fi), Radio Frequency Identification (RFID) or the like.

In this embodiment, although not specifically illustrated, the solar panels 12a, 12b, 30a, 30b are all electrically wired to transmit electrical energy generated in use to an electrical storage unit, specifically a battery. In this embodiment, the system 10 further includes a solar charge controller (for example, Renogy® Adventurer™) configured to prevent the battery from overcharging by regulating the voltage and current coming from the solar panels 12a, 12b, 30a, 30b to the battery. In some embodiments, the solar charge controller may include an interface on which certain electrical parameters of the battery and/or solar changing may be displayed, including for example the current voltage of the battery. In some embodiments, the interface of the solar charge controller may also provide a lower voltage output port for use with suitable appliances (e.g., a 5V 2.4 A output port may be provided on the interface).

In this embodiment, although not specifically illustrated, the expandable solar panel array system 10 further comprises a wireless short-range communications module which is configured to wirelessly communicate predefined electrical parameters of the system 10 to a remote transceiver. More specifically, in this embodiment, the wireless short-range communications module comprises a Bluetooth® module which is operable to wirelessly communicate with a remote Bluetooth® transceiver, specifically a mobile telephone in this example. In this embodiment, the predefined electrical parameters communicated to the remote Bluetooth® transceiver include any one or combination of: estimated state of charge (SOC %), voltage (V), amperes (A) and/or solar power (W) generated by any one or more of the solar panels 12a, 12b, 30a, 30b. In turn, the remote Bluetooth® transceiver and/or a processing unit associated therewith is operable to determine further predefined electrical parameters, including any one or combination of: total energy produced (kWh), battery charging power (W), battery charging volume (V), battery charging current (A), battery type (e.g., flooded), battery temperature (° C.) or controller temperature (° C.). In some embodiments, a user may be able to review these predefined electrical parameters on their mobile telephone via a Bluetooth® based application program interface (API).

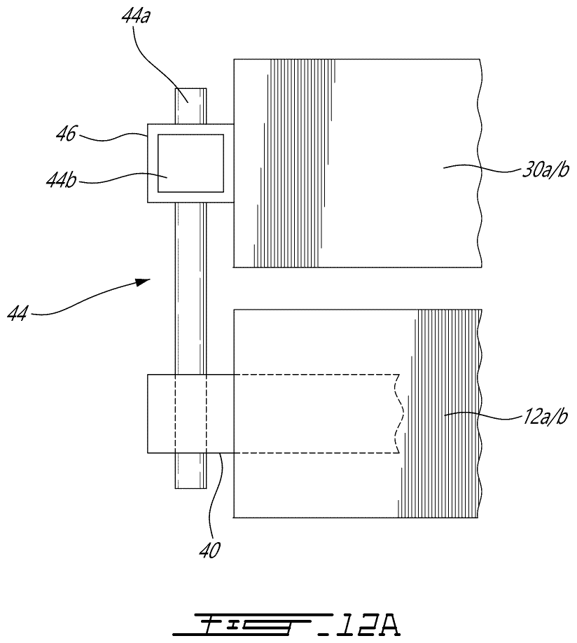

FIG. 11 provides a bottom view of the static solar panels 12a and 12b, in the retracted configuration, showing the linear actuators 38 coupled thereto. One end 42 of each actuator arm 40, as shown for example in FIG. 4, has coupled thereto coupling means 44 for coupling the actuator arm 40 to an outwardly located portion (frame or otherwise) of each moveable solar panel 30a and 30b. In use, as the actuator arm 40 of the linear actuator 38 is extended, the moveable solar panels 30a and 30b are caused to slide outwards relative to the static solar panels 12a and 12b, linearly along the travel path of the sliding mechanism 32, thus at least partially exposing the static solar panels 12a and 12b. In order to the retract or collapse the array 10, the actuator arms 40 are retracted, causing the moveable solar panels 30a and 30b to slide inwards relative to the static solar panels 12a and 12b, linearly along the travel path of the sliding mechanism 32, thus at least partially covering the static solar panels 12a and 12b.

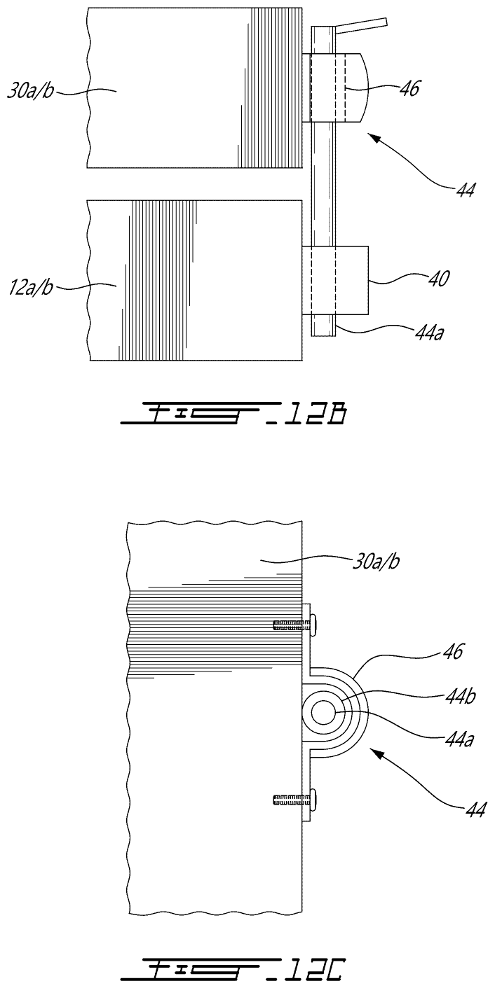

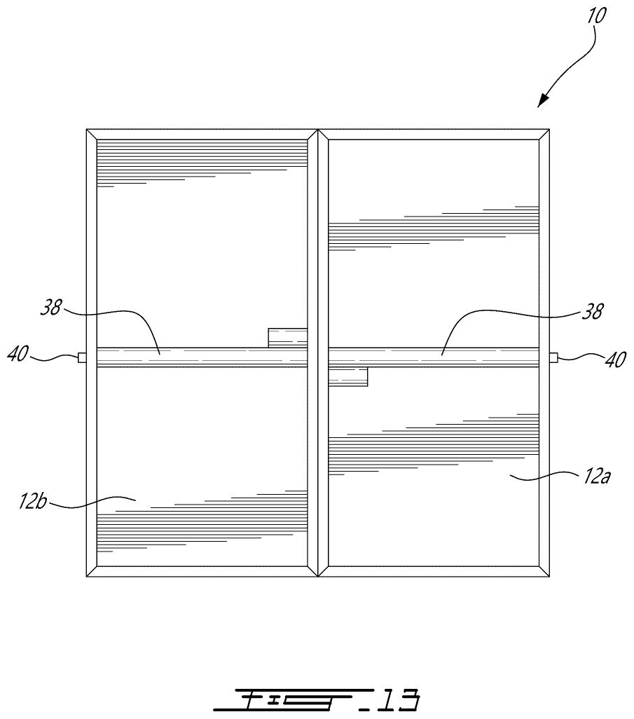

In this embodiment, as shown in FIG. 13, the actuator arm 40 on either side is located at a mid-point of each movable solar panel 30a and 30b. Furthermore, the actuator arm 40 of the linear actuator 38 protrudes beyond the static solar panels 12a and 12b by approximately ½″. This distance allows enough space for the ¼″×3″ locking pin 44a of the coupling means 44 which connects the panels together, as shown, for example, in FIGS. 12A to 12C, when the expandable solar panel array 10 is in its retracted configuration. In some embodiments, the actuators 38 have actuator arms 40 which extend to match the extension capacity of the sliding mechanism 32. In such embodiments, when in the extended configuration, the locking pin 40a extends between the movable solar panel 30a and 30b and the one end 42 of the actuator arm 40.

In some embodiments, small discrepancies between the extension length of the actuator arm 40 and extension capacity of the sliding mechanism 26 (also called “drawer slide” 26 below) may require the design of a flexible locking pin 44a to give up to 3 mm (or more or less) of tolerance. The linear actuators 38 employed in some embodiments may be powerful and although they have extension limits, the drawer slides 26 and the limit switches contained within the linear actuators 38 should stop at precisely the same time. Any tiny discrepancy during the manufacture of the linear actuators 38, actuator arms 40 and/or the drawer slide 26 could cause a failure if the drawer slides 26 stop short, or if the actuator arm 40 is over extended. To address this, the locking device or coupling means 44 design allows for some “movement” or tolerance in some embodiments, which could make up for any variation, or degree of error, in the two motions. In some embodiments, it has been contemplated by the inventor that a 2 to 3 mm tolerance would be sufficient and thus, a rubber grommet 44b is utilized for this purpose, as shown in FIGS. 12A and 12C. It is believed that this allows just enough movement in the event the linear actuators 38, actuator arms 40 and/or drawer slides 26 are not accurately manufactured, or in the event of any possible expansion or contraction of the parts due to temperature, for example. The mounting of the linear actuators 38 and/or actuator arms 40 to the system 10 may also be provided with adjustment means to allow adjustment of the linear actuators 38 and/or actuator arms 40 where they are installed in order to allow accurate movement of the moveable solar panels 30a and 30b between the expanded and collapsed configurations. This adjustment may be required to ensure the distance that the linear actuator arm 40 protrudes through the lower panel is as may be required to allow for the coupling means 44.

As shown, in some exemplary embodiments, for example in FIGS. 12A to 12C, the locking device, or coupling means 44, is designed to attach the movable solar panels 30a and 30b to the linear actuator arms 40 which extend from beneath the static solar panels 12a and 12b (again, FIGS. 12A and 12B show the array 10 in its retracted configuration). As noted, in this embodiment, the locking pin 44a is cushioned with a soft rubber grommet 44b in a “U” clip 46. This setup allows for small differences in the linear actuator 38, linear actuator arm 40 and/or the drawer slide 26, as noted above. The locking pin 44a is purposefully removable, in this embodiment. In the event of major event, such as a power failure, jammed panels, weather event, or vehicle damage, the locking pins 44 on each side of the array 10 can be quickly removed and the movable solar panels 30a and 30b pushed in by hand. In some embodiments, the movable solar panels 30a and 30b can be pushed in with a broom handle or similar device and may lock in place with a detent. However, an additional bungee cord or rope (not shown) should also be used to secure the movable solar panels 30a and 30b in the retracted configuration (“in” position) should it be required, such as if movement of the vehicle is expected.

Turning now FIGS. 1A and 10, among other figures, the frame 14 or in other words, the slide housing 14, is a fabricated piece of aluminum sheet metal, in this embodiment. In other embodiments, the slide housing 14 may be made from one or more other materials, such as fiberglass, extruded aluminum or plastic, stainless steel, carbon fibre, or any other rustproof material. The frame 14 is fastened to the static solar panels 12a and 12b (fixed lower panels) by any suitable means, for example, with rust resistant self-tapping screws 34 of sufficient length and size. As shown in FIG. 10, for example, the sheet metal frame 14 is designed and bent to provide the upper frame portion 22, relative the lower frame portion 24, to receive the drawer slide 26, or frame slide mechanism 26, and the panel side mechanism 28 (not specifically shown), together forming the sliding mechanism 32. One pair of sliding mechanisms 32 is required for each movable solar panel 30a and 30b. The frame slide mechanisms 26, in some embodiments, are riveted to the upper frame portion 22 of the frame 14, and panel side mechanism 28, or, in other words, the removable portion 28 of the sliding mechanism 32, is fastened to the movable solar panels 30a and 30b. This allows for the movable solar panels 30a and 30b to be removed by releasing the clips on the drawer slide 32. Accordingly, in this embodiment, the movable solar panels 30a and 30b are designed to be easily removable. This detachable function of the movable solar panels 30a and 30b, as provided in some embodiments, reduces the weight of the expandable solar panel array 10 for installation. Simply put, the two static solar panels 12a and 12b would be installed first, then the slidable solar panels 30a and 30b may easily be clipped-in by way of the frame slide mechanism 26 and the panel slide mechanism 28 being coupled to form the sliding mechanism 32. Once coupled, the electrical connections to link the various solar panels can be made.

In this embodiment, the slide housing, or frame 14, and specifically the lower frame portion 24 thereof, also acts as a surface to which the mounting brackets 18 are fastened, as shown, for example in FIG. 2. In turn, the mounting brackets 18 may be attached to a vehicle roof or other suitable and desirable surface (not shown for simplicity), using very high bonding tape 17 (for example, VHB™ manufactured by 3M™) or other coupling means, as may be determined to be suitable for the particular application or surface. In the case of VHB™ tape, workable in some embodiments, this tape has proven to be durable and has withstood deluges of rain and high-speed driving.

With reference to FIG. 11, there is shown a bottom view of the expandable solar panel array 10 in the retracted or collapsed configuration. The two linear actuators 38 are shown mounted complete with minor adjustment points. The linear actuators 38, in this embodiment, are 12 volt direct current (DC) actuators hard-wired to draw power from one or more 12 volt batteries of the vehicle. In other embodiments, the linear actuators 38 may be hard-wired to draw solar power from any one or more of the solar panels 12a, 12b, 30a or 30b. In some embodiments, other voltage compatible actuators may be used as required and/or desired for a given application. In this embodiment, an electronic control box 48 as shown in FIG. 11, is used to regulate supply of power to the linear actuators 38. This electronic control box 48, in this embodiment, contains a buck convertor which converts incoming voltage (up to 20 volts) to 12 volts. The output voltage then inputs into a linear actuator controller (not shown) which in turn, controls the linear actuators 38 wirelessly with the use of a key fob, in this embodiment. In some embodiments, the electronic control box 48 contains a 12 volt rechargeable lithium battery which would allow numerous openings and closings of the movable solar panels 30a and 30b but, at some point, the battery would require recharging, which, it is contemplated may be done via the energy generated by the solar panels, drawn from another power source, or by battery replacement, in various embodiments. In some embodiments, a reliable method causing relatively less potential problems for recharging the battery, it is currently believed, is by hardwiring the electronic control box 48 to the electrical system of the vehicle when the array 10 is used on vehicle applications.

In other embodiments, however, using double throw switches in combination with a key fob may be desired. The solar panels can then be deployed, tilted and/or retracted from either inside and/or outside the vehicle. Indeed, using the key fob in some embodiments may well demonstrate the workability of the array system 10 to other solar enthusiasts. In some embodiments, the key fobs may be operated anywhere within 50 feet or more of the vehicle.

In this embodiment, the electrical wires 36 from the static solar panels 12a and 12b are snap tied and placed on an aluminum shelf (not shown) which raises the loose electrical wires above the surface to which the expandable solar panel array 10 is mounted, leaving adequate space for the retracting wires. For the wires 36 which are run from the movable solar panels 30a and 30b, in order to manage these electrical wires 36 to avoid tangling with other wires, the wiring harness, and/or other components, and/or to prevent the electrical wires 36 from scratching or damaging any componentry (including the static solar panels 12a and 12b), a wire guide assembly 50 was designed to contain the wires 36 or similar electrical wiring from the movable solar panels 30a and 30b. It is to be appreciated that the wire guide assembly may be dimensioned to receive therein any number of electrical wires, or the like, and indeed may have an internal diameter suited to same. In some embodiments, that wire guide assembly may be about ½″ in diameter. Once contained, the wires are inhibited from twisting or binding or “hanging-up”, or otherwise prevented from scratching or damaging the static solar panels 12a and 12b. In some embodiments, a conduit is connected with a standard 90-degree electrical box elbow to the movable solar panel 30a and 30b. The conduit is bent 90 degrees to allow the tube to pass easily under the fixed lower panel, as is shown in FIGS. 8 and 9, for example. This solution guides the wires with little or no interference and thus prevents or inhibits binding and tangling of the wires 36, or otherwise scratching or damaging the static solar panel(s) 12a and 12b.

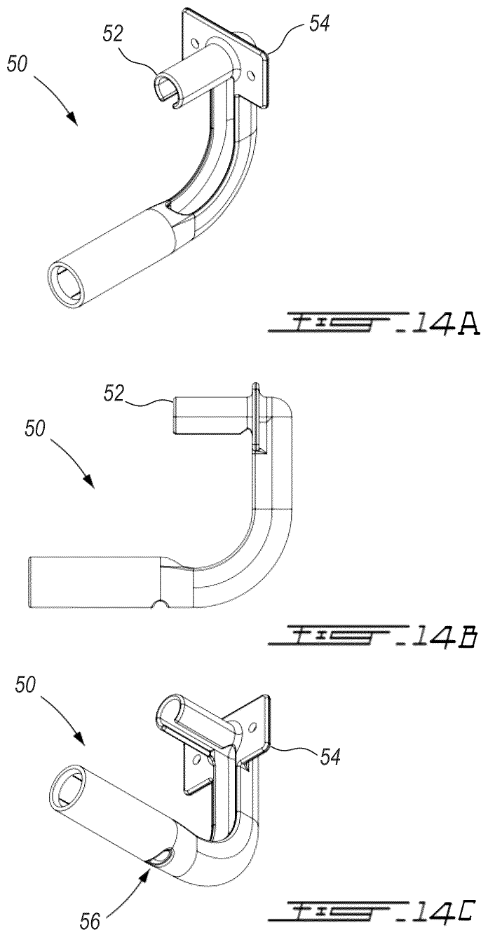

One specific embodiment of the wire guide assembly 50 is shown from various views in FIGS. 14A, 14B and 14C. It is to be appreciated that two such wire guide assemblies 50 would typically be employed where the expandable solar panel array 10 includes two sets of panels. Each wire guide assembly 50 in this embodiment specifically comprises a conduit or tube with a substantially 90-degree bend, as shown in FIG. 14B. In other embodiments, the bend angle may deviate from 90 degrees provided, for example, that the wires 36 from the sliding panel 30a or 30b are indeed guided beneath the static panel 12a or 12b, as described. The wire guide assembly 50 is specifically adapted on its top end to be connectable to the sliding panel 30a or 30b. In this embodiment, the top end has a male mating portion 52 which is shaped and dimensioned to align with and fit into (snugly or otherwise) an aperture in the frame 14 (see FIGS. 8 and 9, for example). The wire guide assembly 50 further includes a mounting plate 54 formed at the top end, specifically formed around the male mating portion 52 and having one or more apertures provided therein. One or more screws (not shown) are used to secure the wire guide assembly 50 to the sliding panel 30a or 30b in this embodiment, although other embodiments may rely on other fasteners or connection means. In this embodiment, the wire guide assembly 50 is three-dimensionally printed from a protective material such as plastic. In this embodiment, the conduit or tube of the wire guide assembly 50 includes one or more cutouts on an interior face which, in this embodiment, provide improved flexibility for mating with the aperture in the frame 14. In this embodiment, the cutouts on interior face of the body of the wire guide assembly 50, may provide additional material savings, and therefore weight and/or cost savings. In this embodiment, the wire guide assembly 50 further includes an outlet 56 on a lower face thereof. In this embodiment, the outlet 56 serves to ensure that any water, condensate or other fluid which may collect in the wire guide assembly 50 during use is able to drain therefrom by means of gravity. For installation, as shown in FIG. 8 and FIG. 9, wires from the movable solar panel 30a and 30b are fed through the aperture in the frame 14 and through the wire guide assembly 50, the wire guide assembly 50 is fit to the frame 14 via the male mating portion 52 (optionally, screws are fastened in the mounting plate 54), the wires are fed through a resiliently expandable flexible tube 58 and the resiliently expandable flexible is connected to the wire guide assembly 50. Notably, as shown in FIG. 3, the wire guide assembly 50 is typically fit to the frame 14 at one side end of the movable solar panel 30a and 30b, such that the wire guide assembly 50 and wiring does not interfere with or entangle with the actuator arm 40.

In this embodiment, the wires from the movable solar panel 30a and 30b are specifically flexible wires which include a pivot point at 90 degrees which allows the wires to swing in an arc. This wiring configuration, in this embodiment, prevents any wiring rigidity from interfering with the wire guide assembly 50 when the movable solar panels 30a and 30b are moved between the retracted and expanded configurations. In other embodiments, any suitable electrical wiring may be employed.

It is to be appreciated that yet further alternative embodiments of the expandable solar panel array 10 are envisaged, without departing from the general nature and scope of the instant disclosure, which are not specifically illustrated in the figures. Some of these embodiments or variations are briefly described hereunder, without limitation.

In other embodiments, other shapes and/or dimensions of the expandable solar panel array 10 are envisaged, not all of which are explicitly described herein but are nonetheless intended to fall within the scope of the instant disclosure.

In other embodiments, the movement of the one or more movable solar panels 30a and 30b may comprise a stepped or staggered movement. In some embodiments, the movable solar panels may move in accordance with a non-linear travel path. For example, the movable solar panels may move up and down/up when actuated, without limitation.

In other embodiments, the solar panels 12a, 12b, 30a, 30b may be electrically wired to directly transmit electrical energy generated in use to an electrically operated device to power the device. For example, the device may comprise a refrigerator and/or freezer which draws relatively large amounts of power. In such embodiments, electrical componentry to regulate power supply to the device may be employed.

It has been contemplated by the inventor that in some embodiments, sensors can be employed to activate the linear actuator 38 and/or actuator arms 40 which could deploy or retract the movable solar panels 30a and 30b when certain conditions are met, such as: low/high battery alarm, day/night conditions, light/dark conditions, moving/stationary (when attached to a vehicle, for example), and the like. Such sensors could form part of the expandable solar panel array 10, or as part of complementary system, in various embodiments, and may be wired or wirelessly connected to a control box (not shown). In different embodiments, the control box may be connected to the system 10 as a closed system (i.e., only connected to the solar panels) or may be connected to the vehicle system (i.e., also integrated with vehicle commands), or may be connected to a cloud or network environment (i.e., satellite internet, cellular, or other network) which would allow monitoring and control of the sensors and/or the system 10 via a remote interface (i.e., web interface, mobile phone application).

In some embodiments, tilting solar panels towards the sun to optimize the energy capture may be desirable and is contemplated by the inventor in some embodiments. Tilting combined with solar tracking by some means is contemplated, but tracking may be more practical with fixed installations, however a solar tracking unit (not shown) may be provided in some embodiments in order to dynamically track the sun relative to an installation site to optimize the energy capture by the solar panels. In some embodiments, the mounting brackets 18 may also be fashioned to allow the expandable solar panel array 10 to pivot or radially articulate relative to the vehicle surface, for example, for optimal energy capture. Furthermore, it is contemplated by the inventor that in some embodiments, the mounting bracket 18 may serve as a coupling region for a tilting linear actuator (not shown) used to tilt any one or more of the solar panels.

It should be noted that more than one, or as described herein in the exemplary embodiments, more than two static solar panels and more than two movable solar panels may be used in various embodiments, and similarly in arranged in a stacked or nesting arrangement as shown herein, to be expanded and retracted on demand. For example, in one embodiment, the array 10 may include one static panel having two movable panels suspended above it. In such an embodiment, the two movable panels may both slide to one side of the static panel, each movable panel associated with an actuator and actuator arm of appropriate length to expose the panel(s) beneath it. Otherwise, the two movable panels may slide to different sides of the static panel to expose it. Indeed, it is envisaged that various embodiments will include various numbers of static and/or movable solar panels, wherein wire guide assemblies are similarly configured so as to avoid wiring entanglement and/or damage caused to lower solar panel in a stack or the like.

In other embodiments, although not specifically illustrated, the array 10 may include three stacked solar panels, with the lowest solar panel being static and both the upper solar panel and the uppermost solar panel being movable, specifically by means of sliding mechanisms, relative to the static panel. In one embodiment, the upper solar panel and the uppermost solar panel may slidably move in opposition directions away from the lowest solar panel, whilst in another embodiment these upper solar panels may slidably move in the same direction away from the lowest solar panel, with the upper solar panel moving distance A from the lowest solar panel and the uppermost solar panel moving distance A+B away from the lowest solar panel, such that all three solar panels are exposed. Notably, any number of solar panels may be workable in different embodiments and indeed, the direction of movement of these solar panels may be independent and adapted to the particular intended application.

In yet other embodiments, the expandable solar panel array 10 may be provided or made available for purchase as an installable kit. Such a kit may comprise any one or combination of the componentry described herein, such that a user may install the kit on a vehicle or other structure. In one embodiment, a solar panel installation kit for installing at least two solar panels on a vehicle is provided. The solar panel installation kit generally comprises a rigid frame comprising at least two solar panel mounting structures arranged in a stacked configuration, the at least two solar panel mounting structures comprising an upper solar panel mounting structure slidably engaged with a lower solar panel mounting structure via a sliding mechanism such that the upper solar panel mounting structure is slidably translatable with respect to the lower solar panel mounting structure along a travel path from a retracted configuration to an extended configuration, at least two solar panels shaped and dimensioned to mount to the at least two solar panel mounting structures, and at least one wiring guide assembly couplable to the upper solar panel mounting structure for at least partially receiving therein electrical wiring from an upper solar panel and routing the electrical wiring at least partially beneath the lower solar panel mounting structure, such that the electrical wiring is at least partially retained within the at least one wire guide assembly during translation of the upper solar panel mounting structure.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, workpiece, and fabrication material detail may be made, without departing from the spirit and scope of the present disclosure, as set forth in the appended claims, as may be apparent to those of ordinary skill in the art, are also encompassed by the disclosure.

1. An expandable solar panel array system, comprising:
at least one static solar panel located beneath at least one movable solar panel, said at least one movable solar panel being slidably translatable along a travel path with respect to said at least one static solar panel;
a first frame member and a second frame member, each having a lower frame portion and an upper frame portion, said lower frame portion of said first frame member and said lower frame portion of said second frame member being coupled together along opposing sides of said at least one static solar panel, said upper frame portion of said first frame member and said upper frame portion of said second frame member each having a sliding mechanism associated therewith and intervening to opposing sides of said at least one movable solar panel, wherein said sliding mechanism is configured to slidably translate said at least one movable solar panel along said travel path with respect to said at least one static solar panel between a retracted configuration and an extended configuration; and
a wire guide assembly configured to at least partially receive therein electrical wiring for said at least one movable solar panel and to route same at least partially beneath said at least one static solar panel, such that said electrical wiring is at least partially retained within said wire guide assembly during translation of said at least one movable solar panel.

2. (canceled)

3. The expandable solar panel array system of claim 1, wherein when in said extended configuration, said at least one movable solar panel is orientated at a plane above or in line with said at least one static solar panel.

4. The expandable solar panel array system of claim 1, where said wire guide assembly is removably coupled to one end of said at least one movable solar panel and is configured to extend at least partially beneath said at least one static solar panel.

5. The expandable solar panel array system of claim 1, wherein said wire guide assembly comprises a conduit for guiding said electrical wiring for said at least one movable solar panel at least partially beneath said at least one static solar panel.

6. The expandable solar panel array system of claim 5, wherein said conduit comprises a substantially 90-degree bend.

7. The expandable solar panel array system of claim 1, wherein said wire guide assembly further comprises a resiliently expandable conduit coupled to a free end of said conduit, said resiliently expandable conduit extending said wire guide assembly to a wiring harness located beneath said at least one static solar panel.

8. The expandable solar panel array system of claim 1, wherein each sliding mechanism comprises complementary sliding faces located on said upper frame portions of said first and second frame members, and on opposing sides of said at least one movable solar panel.

9. (canceled)

10. The expandable solar panel array system of claim 1, further comprising an actuator mechanism for translating said at least one movable solar panel along said travel path.

11. The expandable solar panel array system of claim 10, wherein said actuator mechanism comprises:
a linear actuator mounted to a bottom side of said at least one static solar panel; and
an actuator arm having a first end and a second end, said first end coupled to said linear actuator and said second end coupled to said at least one movable solar panel, said actuator arm being extendable along said travel path beneath said at least one movable solar panel.

12. (canceled)

13. The expandable solar panel array system of claim 11, wherein said second end of said actuator arm is releasably coupled to one edge of said at least one movable solar panel by a locking pin.

14. The expandable solar panel array system of claim 1, wherein any one or both of said first frame member and said second frame member have an attachment point for removably coupling the expandable solar panel array system to a surface.

15. (canceled)

16. The expandable solar panel array system of claim 14, wherein said attachment point is configured to provide radial articulation of said expandable solar panel array system relative to said surface.

17. The expandable solar panel array system of claim 16, comprising a tilt actuator located between an edge of said at least one movable solar panel and framing around said at least one static solar panel for tilting said edge of said at least one movable solar panel upwards relative to said at least one static solar panel.

18. (canceled)

19. (canceled)

20. The expandable solar panel array system of claim 10, further comprising an electronic control box configured to control said actuator mechanism for movement of said at least one movable solar panel along said travel path relative to said at least one static solar panel, the electronic control box further configured to at least on control input signal.

21. (canceled)

22. (canceled)

23. The expandable solar panel array system of claim 1, wherein said at least one static solar panel and said at least one movable solar panel are electrically wired to transmit electrical energy generated in use to any one of an electrically operated device and/or an electrical storage unit.

24. (canceled)

25. (canceled)

26. (canceled)

27. (canceled)

28. (canceled)

29. (canceled)

30. A solar panel installation kit for installing at least two solar panels on a vehicle, the solar panel installation kit comprising:
a rigid frame comprising at least two solar panel mounting structures arranged in a stacked configuration, said at least two solar panel mounting structures comprising an upper solar panel mounting structure slidably engaged with a lower solar panel mounting structure via a sliding mechanism such that said upper solar panel mounting structure is slidably translatable with respect to said lower solar panel mounting structure along a travel path from a retracted configuration to an extended configuration;
at least two solar panels shaped and dimensioned to mount to said at least two solar panel mounting structures; and
at least one wire guide assembly couplable to said upper solar panel mounting structure for at least partially receiving therein electrical wiring from an upper solar panel and routing said electrical wiring at least partially beneath said lower solar panel mounting structure, such that said electrical wiring is at least partially retained within said at least one wire guide assembly during translation of said upper solar panel mounting structure.

31. (canceled)

32. (canceled)

33. (canceled)

34. (canceled)

35. The solar panel installation kit of claim 30, wherein said at least one wire guide assembly comprises a conduit having a substantially 90-degree bend.

36. The solar panel installation kit of claim 35, wherein said at least one wire guide assembly further comprises a resiliently expandable conduit couplable to a free end of said conduit, said resiliently expandable conduit in use extending said at least one wire guide assembly to a wiring harness located beneath said lower solar panel mounting structure.

37. (canceled)

38. (canceled)

39. The solar panel installation kit of claim 30, further comprising an actuator mechanism for translating said upper solar panel mounting structure along said travel path, wherein said actuator mechanism comprises:
a linear actuator mountable to a bottom side of said lower solar panel mounting structure; and
an actuator arm having a first end and a second end, said first end couplable to said linear actuator and said second end couplable to said upper solar panel mounting structure, said actuator arm being extendable along said travel path beneath said lower solar panel mounting structure.

40. The solar panel installation kit of claim 30, further comprising a mounting bracket for removably coupling said lower solar panel mounting structure to a vehicle surface.

41. (canceled)

42. (canceled)

43. (canceled)

44. (canceled)

45. (canceled)

46. (canceled)
